(19) United States
(12) Patent Application Publication
(10) Pub. No.: US 2025/0332755 A1
(43) Pub. Date: Oct. 30, 2025

(54) CIRCULAR SAW

(71) Applicant: MILWAUKEE ELECTRIC TOOL CORPORATION, Brookfield, WI (US)

(72) Inventors: David S. Koper, Milwaukee, WI (US); Nathan P. Bandy, Wauwatosa, WI (US); Eric W. Oeding, Sussex, WI (US); Ryan Khatib, Waukesha, WI (US); Mitchell A. Ellena, West Allis, WI (US); Jonathon R. Gasteiner, Brookfield, WI (US); Lokeshwaran Rajendran, Waukesha, WI (US); Vincent M. Zornow, Milwaukee, WI (US)

(21) Appl. No.: 19/186,214

(22) Filed: Apr. 22, 2025

Related U.S. Application Data
(60) Provisional application No. 63/639,251, filed on Apr. 26, 2024.

(51) Int. Cl. B27G 19/04; B27B 9/02; B27G 19/02; H02P 23/00

(52) U.S. Cl. CPC B27G 19/04; B27G 19/025; H02P 23/009; B27B 9/02; H02P 2207/05

(57) ABSTRACT

A circular saw may include a shoe and a blade guard assembly coupled to the shoe, the blade guard assembly including an upper blade guard and a lower blade guard movable between an extended position and a retracted position. A circular saw may include a housing assembly coupled to the blade guard assembly, an output shaft, and a blade clamp coupled to output shaft, the blade clamp configured to hold the saw blade. A circular saw may include a brushless direct current (DC) motor positioned within the housing assembly and operable to rotate the output shaft. A circular saw may include an electronic controller configured to perform a field weakening operation on the brushless DC motor.

### CROSS-REFERENCE TO RELATED APPLICATIONS

This application claims priority to co-pending U.S. Provisional Patent Application No. 63/639,251, filed Apr. 26, 2024, the entire content of which is hereby incorporated by reference.

### FIELD OF THE DISCLOSURE

The present disclosure relates to power tools and, more particularly, to circular saws.

### BACKGROUND OF THE DISCLOSURE

Powered cutting tools, such as portable circular saws, can rotate circular blades to cut work pieces made of a variety of materials, such as, e.g., metals, plastics, fiber, wood, etc.

### SUMMARY OF THE DISCLOSURE

The present disclosure provides, in one aspect, a circular saw configured to operate a saw blade having a diameter of 5⅜ inches, the circular saw including: a shoe defining a slot and a workpiece contact surface; a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface; a housing assembly coupled to the blade guard assembly; an output shaft; a blade clamp coupled to output shaft, the blade clamp configured to hold the saw blade; a brushless direct current (DC) motor positioned within the housing assembly and operable to rotate the output shaft; an electronic controller configured to: set a conduction angle of the brushless DC motor, supply a pulse-width modulated (“PWM”) signal having a duty cycle to the brushless DC motor to control a current of the brushless DC motor, and perform a field weakening operation to modify the conduction angle of the brushless DC motor; wherein the circular saw is configured to operate with a battery pack having a nominal voltage rating of approximately 12 Volts; wherein in response to the lower blade guard residing in the retracted position, the circular saw fits entirely within a volume bounded by a rectangular prism; wherein the brushless DC motor is configured to produce a peak power; and wherein a power-volume ratio of the peak power to the volume is greater than or equal to 1.00 Watts/in.3 and less than or equal to 2.00 Watts/in.3.

The present disclosure provides, in another aspect, a circular saw configured to operate a saw blade having a diameter of 5⅜ inches, the circular saw including: a shoe defining a slot and a workpiece contact surface; a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface; a housing assembly coupled to the blade guard assembly; an output shaft; a blade clamp coupled to output shaft, the blade clamp configured to hold the saw blade; a brushless direct current (DC) motor positioned within the housing assembly and operable to rotate the output shaft; an electronic controller configured to: set a conduction angle of the brushless DC motor, supply a pulse-width modulated (“PWM”) signal having a duty cycle to the brushless DC motor to control a current of the brushless DC motor, and perform a field weakening operation to modify the conduction angle of the brushless DC motor; wherein the circular saw is configured to operate with a battery pack having a nominal voltage rating of approximately 12 Volts; wherein the circular saw defines a weight; wherein the brushless DC motor is configured to produce a peak power; and wherein a power-weight ratio of the peak power to the weight is greater than or equal to 105 Watts/lb. and less than or equal to 150 Watts/lb.

The present disclosure provides, in another aspect, a circular saw configured to operate a saw blade having a diameter of 5⅜ inches, the circular saw including: a shoe defining a slot and a workpiece contact surface; a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface; a housing assembly coupled to the blade guard assembly; an output shaft; a blade clamp coupled to output shaft, the blade clamp configured to hold the saw blade; and a brushless direct current (DC) motor positioned within the housing assembly and operable to rotate the output shaft; wherein the circular saw is configured to operate with a battery pack having a nominal voltage rating of approximately 12 Volts; wherein in response to the lower blade guard residing in the retracted position, the circular saw fits entirely within a volume bounded by a rectangular prism; wherein the brushless DC motor is configured to produce a peak power; wherein the volume is less than or equal to 450 cubic inches (in3); and wherein a power-volume ratio of the peak power to the volume is greater than or equal to 1.00 Watts/in.3 and less than or equal to 2.00 Watts/in.3.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the disclosure will become apparent by consideration of the detailed description and accompanying drawings.

### BRIEF DESCRIPTION OF THE DRAWINGS

FIG. 1 is a front perspective view of an embodiment of a circular saw according to the present disclosure.

FIG. 2 is a rear perspective view of the circular saw of FIG. 1.

FIG. 3 is a side view of a saw blade operable with the circular saw of FIG. 1.

FIGS. 4 and 5 are bottom and top views, respectively, of the circular saw of FIG. 1.

FIG. 6 is a cross-sectional view of the circular saw of FIG. 1, taken along line 6-6 of FIG. 1.

FIG. 7 is another cross-sectional view of the circular saw of FIG. 1, taken along line 7-7 of FIG. 1.

FIG. 8 is another cross-sectional view of the circular saw of FIG. 1, taken along line 8-8 of FIG. 1

FIG. 9 is a block diagram of the circular saw of FIG. 1.

FIG. 10 is a block diagram of a field weakening technique executed by a controller of the circular saw of FIG. 1.

FIG. 11 is a graph showing commutation of a brushless motor of the circular saw of FIG. 1.

FIG. 12 is a graph illustrating relationships between torque and speed based on the field weakening technique described in connection with FIGS. 10 and 11.

FIG. 13 is a perspective view of a battery pack, such as a low-capacity battery pack, operable with the circular saw of FIG. 1.

FIG. 14 schematically shows a group of cells of the battery pack of FIG. 13.

FIG. 15 is a perspective view of a battery pack, such as a high-capacity battery pack, operable with the circular saw of FIG. 1.

FIG. 16 schematically shows a group of cells of the battery pack of FIG. 15.

FIG. 17 illustrates a circuit diagram for a switching module of the circular saw of FIG. 1.

FIGS. 18A-18C illustrate a flow chart for a method for determining an impedance of a battery pack, such as the battery packs of FIGS. 15 and 17.

FIG. 19 illustrates a flow chart for a method for controlling field weakening of the electric motor of the circular saw of FIG. 1 using a classification of the battery pack.

FIGS. 20-22 are side, front, and top views, respectively, of the circular saw of FIG. 1 configured with the battery pack removed and with a lower blade guard located in a retracted position.

FIGS. 23 and 24 are front and rear perspective views, respectively, of the circular saw of FIG. 1 configured with the battery pack removed and with the lower blade guard located in the retracted position.

FIG. 25 is a side view of the circular saw of FIG. 1 configured with the battery pack of FIG. 15 connected thereto and with the lower blade guard located in the retracted position.

FIG. 26 is a rear perspective view of the circular saw of FIG. 1 configured with the battery pack of FIG. 15 connected thereto and with the lower blade guard located in the retracted position.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein, the terms “upper”, “lower”, and other directional terms are not intended to require any particular orientation but are instead used for purposes of description only.

### DETAILED DESCRIPTION

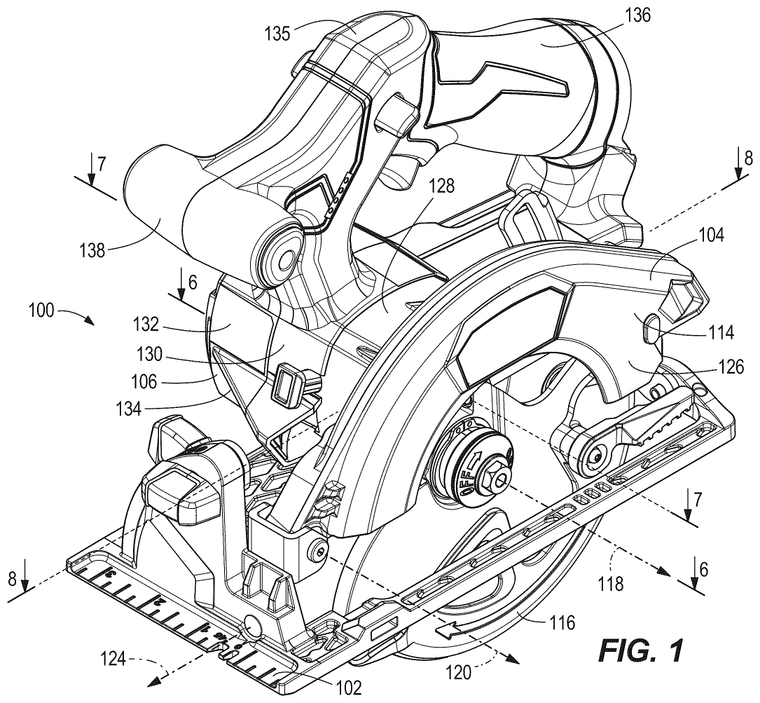

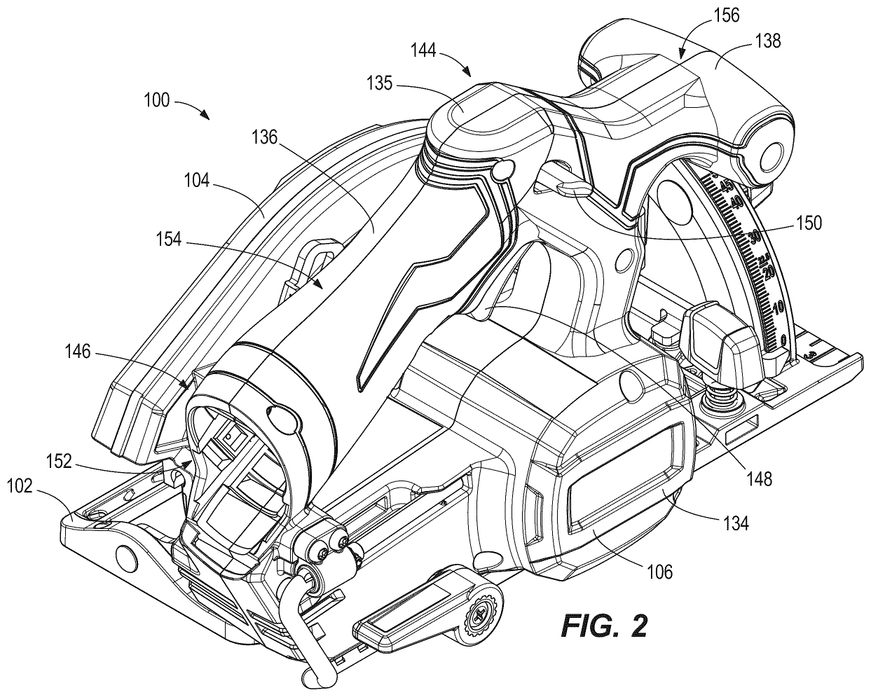

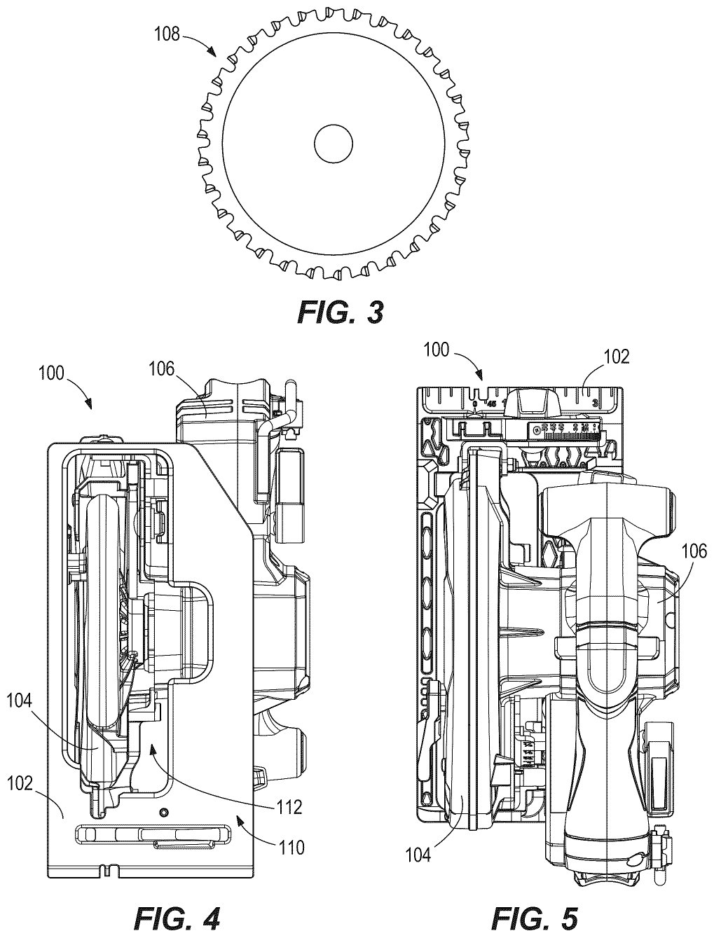

FIGS. 1 and 2 illustrate a power tool in the form of a circular saw 100. The circular saw 100 includes a base or shoe 102, a blade guard assembly 104 adjustably coupled to the shoe 102, and a housing assembly 106 coupled to the blade guard assembly 104. The circular saw 100 removably couples to a saw blade 108 (FIG. 3) which, when coupled thereto, resides at least partially within the blade guard assembly 104. The saw blade 108 may be, e.g., 5⅜ inches in diameter. The circular saw 100 is operable to rotate the saw blade 108 at a high rate of speed to cut a workpiece.

The shoe 102 defines a workpiece contact surface 110 (FIG. 4) that is generally flat and contacts the workpiece during cutting operations. The shoe 102 also defines a slot 112 through which portions of the saw blade 108 and portions of the blade guard assembly 104 can protrude to varying extents.

With continued refence to FIGS. 1 and 2, the blade guard assembly 104 includes an upper blade guard 114 and a lower blade guard 116 pivotably attached to the upper blade guard 114. The upper blade guard 114 is fixedly attached to the housing assembly 106 and covers an upper portion of the saw blade 108 when the saw blade 108 is coupled to the circular saw 100. The lower blade guard 116 selectively covers a lower portion of the saw blade 108 below the shoe 102 so that only a small portion of the saw blade 108 is exposed when the circular saw 100 is not in use. The lower blade guard 116 is rotatable relative to the upper blade guard 114 about a rotation axis 118 to selectively expose the lower portion of the saw blade 108. During a cutting operation, the lower blade guard 116 engages the workpiece and forward displacement of the circular saw 100 causes the lower blade guard 116 to pivot to expose the lower portion of the saw blade 108 to the workpiece.

The shoe 102 is adjustably coupled to the upper blade guard 114 and supports the circular saw 100 on the workpiece. The shoe 102 is pivotable with respect to the upper blade guard 114 about a first pivot axis 120 (FIG. 1) that extends parallel to the rotation axis 118. Pivoting the shoe 102 relative to the upper blade guard 114 about the first pivot axis 120 moves the shoe generally toward or away from the housing assembly 106 and adjusts an extent to which the saw blade 108 protrudes through the slot 112, thereby adjusting a cutting depth of the saw blade 108. The shoe 102 is also pivotable with respect to the upper blade guard 114 about a second pivot axis 124 (FIG. 1) that extends parallel to the rotation axis 118 and perpendicular to the first pivot axis 120. Pivoting the shoe 102 relative to the upper blade guard 114 about the second pivot axis 124 adjusts a bevel angle of the saw blade 108 measured relative to the workpiece contact surface 110.

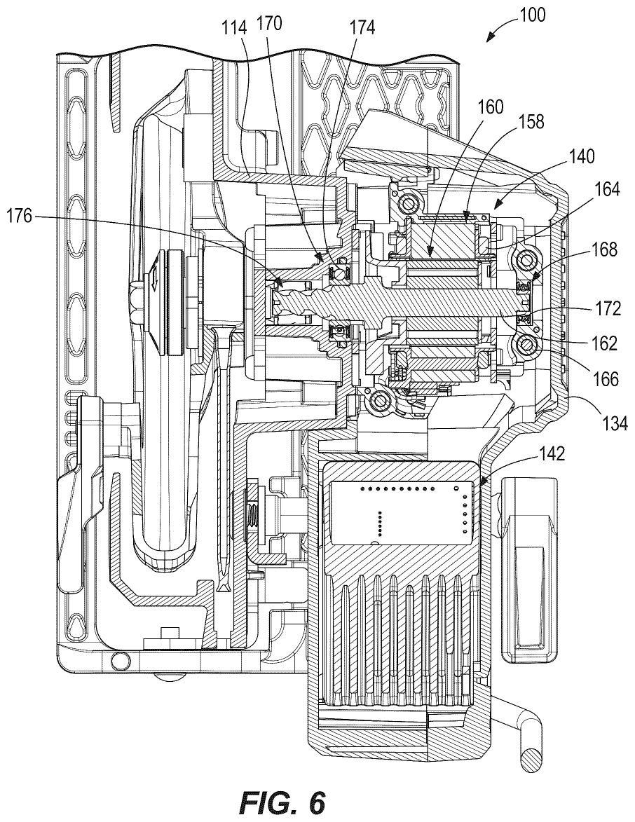

With reference to FIGS. 1 and 2, the upper blade guard 114 includes a guard portion 126 which surrounds the upper portion of the saw blade 108, and a hub portion 128 which is fixedly attached to the housing assembly 106 (e.g., by threaded fasteners). The housing assembly 106 includes a first clamshell housing half 130 and a second clamshell housing half 132. The first clamshell housing half 130 is fixedly attached to the hub portion 128 and the second clamshell housing half 132 is fixedly attached to the first clamshell housing half 130 (e.g., by threaded fasteners). The housing assembly 106 also defines a motor housing portion 134 and a handle portion 135. The handle portion 135 includes a primary handle portion 136 and a secondary handle portion 138. The motor housing portion 134 contains an electric motor 140 (FIG. 6) which provides a rotational output to drive rotation of the saw blade 108. The motor housing portion 134 also houses a printed circuit board assembly 142 (PCBA 142) which controls the operation of the electric motor 140 and other features of the circular saw 100.

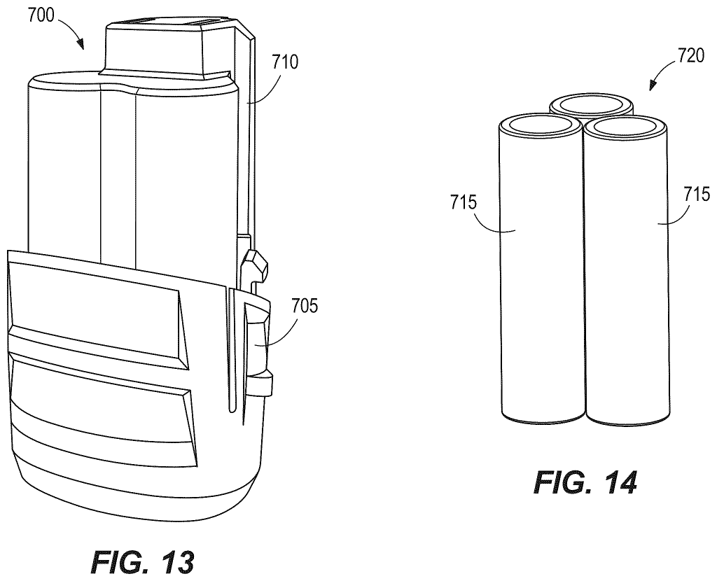

With reference to FIG. 2, the primary handle portion 136 connects to the motor housing portion 134 and extends between a first end 144 and a second end 146. The primary handle portion 136 supports a trigger 148 and a lockout mechanism 150 adjacent the first end 144, and defines a battery receptacle 152 at the second end 146. The battery receptacle 152 selectively and removably receives a battery pack, such as the battery pack 700 and the battery pack 800 described herein with respect to FIGS. 13-16. When the battery pack is coupled to the battery receptacle 152, the battery pack supplies electrical power to the electrical components of the circular saw 100 such as the electric motor 140, the printed circuit board assembly 142, etc. The primary handle portion 136 further defines a first gripping region 154 which may be gripped by a user to hold, carry, and operate the circular saw 100. The secondary handle portion 138 is connected to the primary handle portion 136 and protrudes generally away from the first end 144. The secondary handle portion 138 defines a second gripping region 156.

With reference to FIG. 6, the electric motor 140 is positioned within the motor housing portion 134 and includes a stator assembly 158, a rotor assembly 160 which rotates within the stator assembly 158, and a motor shaft 162 that supports the rotor assembly 160 for corotation therewith. In the illustrated embodiment, the electric motor 140 is a brushless, direct current (BLDC) electric motor 140 that is electronically commutated by a controller supported on the PCBA 142 as will be described herein. The stator assembly 158 includes a plurality of coils 164 that are selectively energized with a current supplied from the battery pack.

The stator assembly 158 is fixedly supported by a motor frame 166 which is affixed to the upper blade guard 114. The motor frame 166 and the upper blade guard 114 define respective motor bearing pockets 168, 170 which receive respective motor bearings 172, 174. The motor bearings 172, 174 support the motor shaft 162 for rotation relative to the stator assembly 158, the upper blade guard 114, and the motor frame 166. An output gear 176, such as a pinion, is affixed to an end of the motor shaft 162 (or, formed integrally therewith).

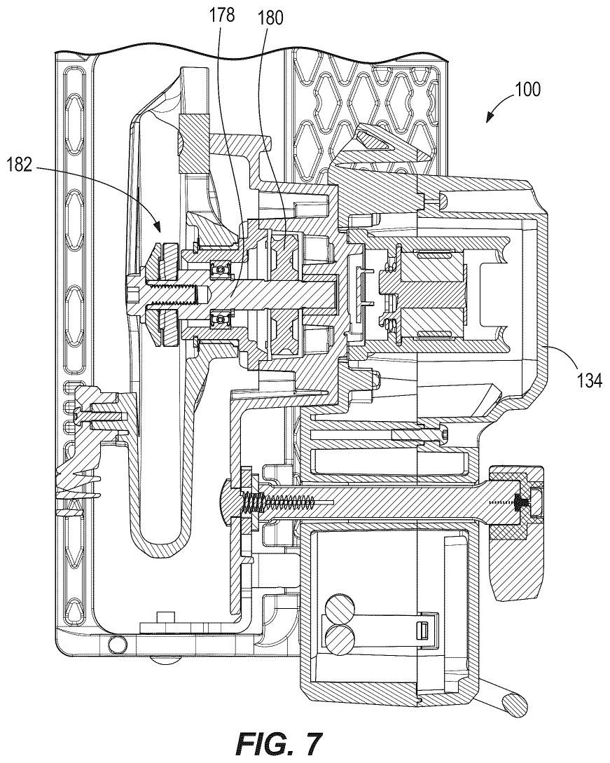

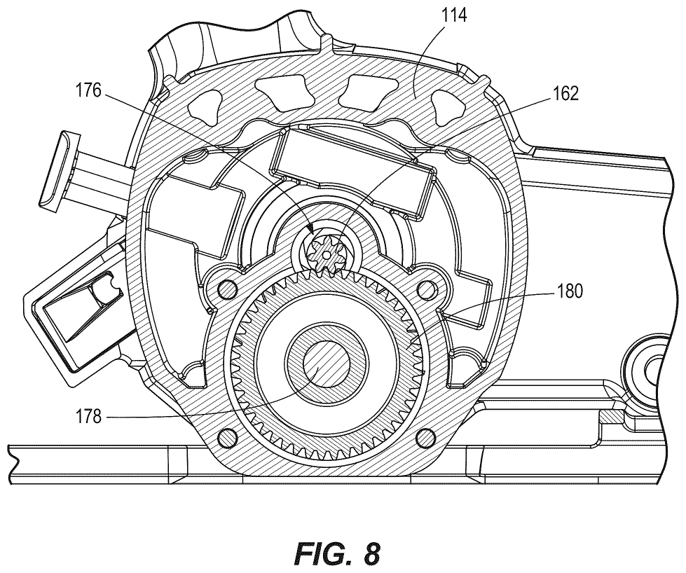

With reference to FIGS. 7 and 8, the circular saw 100 also includes an output shaft 178 or spindle that is rotatably supported adjacent the motor shaft 162. The output shaft 178 supports a driven gear 180 that is affixed to the output shaft 178 for corotation therewith. The output gear 176 meshes with the driven gear 180 to transfer torque from the motor shaft 162 to the output shaft 178 and achieve a gear reduction. The output shaft 178 supports a blade clamp 182 that is operable to selectively secure the saw blade 108 to the output shaft 178. As such, the output shaft 178 selectively supports and rotatably drives the saw blade 108 during operation of the circular saw 100.

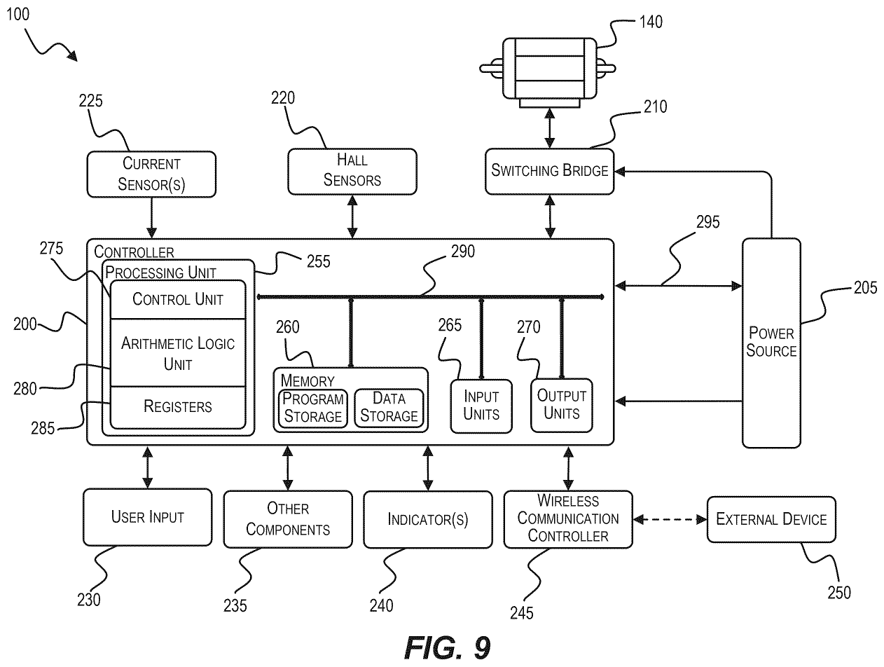

FIG. 9 illustrates an electromechanical diagram of the circular saw 100, which includes a controller 200. The controller 200 may be supported on the PCBA 142 and is electrically and/or communicatively connected to a variety of modules or components of the circular saw 100. For example, the illustrated controller 200 is connected to a power source 205 (e.g., such as one of the battery packs 700, 800), a switching bridge 210, the electric motor 140, Hall Effect sensors 220 (also referred to as Hall sensors), one or more current sensors 225, a user input 230 (e.g., the trigger 148), other components 235 (e.g., a battery pack fuel gauge, work lights [e.g., LEDs], current/voltage sensors, etc.), one or more indicators 240 (e.g., LEDs), and a wireless communication controller 245 (e.g., a transceiver) configured to communicate with an external device 250 (e.g., a smartphone, a tablet computer, a laptop computer, and the like).

The controller 200 includes combinations of hardware and software that are operable to, among other things, control the operation of the circular saw 100, control power provided to the electric motor 140, etc. In some embodiments, the controller 200 includes a plurality of electrical and electronic components that provide power, operational control, and protection to the components and modules within the controller 200 and/or circular saw 100. For example, the controller 200 includes, among other things, a processing unit 255 (e.g., a microprocessor, a microcontroller, or another suitable programmable device), a memory 260, input units 265, and output units 270. The processing unit 255 includes, among other things, a control unit 275, an arithmetic logic unit (“ALU”) 280, and a plurality of registers 285 (shown as a group of registers in FIG. 2), and is implemented using a known computer architecture (e.g., a modified Harvard architecture, a von Neumann architecture, etc.). The processing unit 255, the memory 260, the input units 265, and the output units 270, as well as the various modules connected to the controller 200 are connected by one or more control and/or data buses (e.g., common bus 290). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 260 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 255 is connected to the memory 260 and executes software instructions that are capable of being stored in a RAM of the memory 260 (e.g., during execution), a ROM of the memory 260 (e.g., on a generally permanent basis), or another non-transitory computer readable medium such as another memory or a disc. Software included in the implementation of the circular saw 100 can be stored in the memory 260 of the controller 200. The software includes, for example, firmware, one or more applications, program data, filters, rules, one or more program modules, and other executable instructions. The controller 200 is configured to retrieve from memory and execute, among other things, instructions related to the control of the circular saw 100 described herein. In other constructions, the controller 200 includes additional, fewer, or different components.

The power source 205 provides DC power to the various components of the circular saw 100. In some embodiments, the power source 205 is the battery pack (e.g., such as one of the battery packs 700, 800), which is rechargeable and uses, for example, lithium ion battery cell technology. In some embodiments, the circular saw 100 includes, for example, a communication line 295 for providing a communication line or link between the controller 200 and the power source 205.

Each of the Hall effect sensors 220 outputs motor feedback information, such as an indication (e.g., a pulse) related to when a magnet of the rotor assembly 160 rotates across the face of that Hall effect sensor 220. Based on the motor feedback information from the Hall effect sensors 220, the controller 200 is able to determine the rotational position, speed, and acceleration of the rotor assembly 160. The one or more current sensors 225 output information regarding the current supplied to the electric motor 140 and/or the circular saw 100.

The circular saw 100 is configured to operate in various modes. For example, the controller 200 receives user controls from the user input 230, such as by depressing the trigger 148 or actuating any other user input 230 of the circular saw 100. In response to the motor feedback information and user controls, the controller 200 generates control signals to control the switching bridge 210 (e.g., a FET switching bridge) to drive the electric motor 140. For example, the switching bridge 210 may include a plurality of high side switching elements (e.g., FETs) and a plurality of low side switching elements. By selectively enabling and disabling the switches of the switching bridge 210, power from the power source 205 is selectively applied to the coils 164 of the electric motor 140 to cause rotation of the rotor assembly 160. Although not shown explicitly, the one or more current sensors 225 and other components of the circular saw 100 are electrically coupled to the power source 205 such that the power source 205 provides power to those components.

In some embodiments, controller 200 also controls other aspects of the circular saw 100 such as, for example, recording usage data, communication with an external device, and the like.

In some embodiments, the circular saw 100 is configured to control the operation of the electric motor 140 based on the detected current supplied by the power source 205. For example, in some embodiments, the controller 200 is configured to monitor a current supplied by the power source 205 via the information output by the one or more current sensors 225. The controller 200 can then control the electric motor 140 based on the detected current supplied by the power source 205. By monitoring the electric motor 140 and the power source 205, the controller 200 can control the electric motor 140 at the highest efficiency while achieving the highest torque available at the lowest possible current over the entire range of input voltages (e.g., battery pack voltage) and motor speeds.

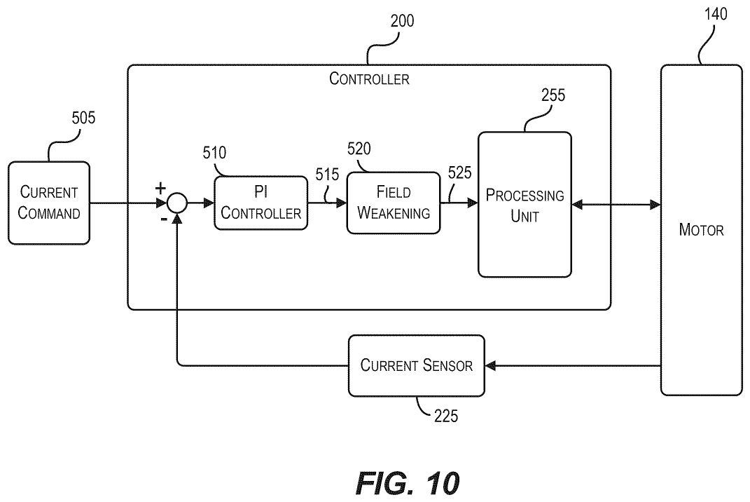

FIG. 10 illustrates a block diagram of a current-based field weakening control executed by the controller 200, according to some embodiments. Field weakening control techniques for electric motors in power tools are described in greater detail in, for example, U.S. Patent Application Publication No. 2024/0048085, published on Feb. 8, 2024, and entitled “POWER TOOL INCLUDING CURRENT-BASED FIELD WEAKENING,” and in International Patent Application Publication No. WO2023/137412, published Jul. 20, 2023 and entitled “POWER TOOL CONTROLLING FIELD WEAKENING,” the entire content of each of which is hereby incorporated by reference.

In the embodiment illustrated in FIG. 10, the controller 200 further includes a proportional-integral (“PI”) controller 510 and a field weakening controller 520 (e.g., stored within the memory 260). As previously described, the one or more current sensors 225 sense information regarding the current supplied to the electric motor 140 and/or the circular saw 100. The controller 200 receives a signal indicative of the current supplied to the electric motor 140 via the one or more current sensors 225. The controller 200 generates a current command 505 that is combined with a sensed current feedback signal from the current sensor 225 and provided to the PI controller 510. Based on the current command 505 and the sensed current from the current sensor 225, the PI controller 510 generates and provides one or more field weakening reference signals 515 to the field weakening controller 520. In some embodiments, the field weakening controller 520 determines one or more motor control signals 525 to provide the processing unit 255. For example, the one or more motor control signals 525 can be indicative of a pulse-width modulation (“PWM”) signal with a duty cycle and/or a conduction angle (e.g., a conduction angle in degrees) to provide to the electric motor 140 to execute a control operation. Based on the one or more motor control signals 525, the processing unit 255 determines, for example, a PWM signal having a duty cycle and a conduction angle to apply to the electric motor 140. The sensed current feedback signal in conjunction with a subsequently generated current command 505 are provided to the PI controller 510 to initiate a subsequent control operation. In some embodiments, the subsequent field weakening operation includes a first variation in the PWM signal applied to the electric motor 140. In some embodiments, the controller 200 receives a sensed current feedback signal, via the one or more current sensors 225, indicative of a current supplied by the electric motor 140 during the control operation when the conduction angle is used to increase the current applied to the electric motor 140. The current feedback signal in conjunction with a subsequently generated current command 505 are again provided to the PI controller 510 to initiate a subsequent control operation. In some embodiments, the subsequent field weakening operation includes a first variation in the conduction angle applied to the electric motor 140 (e.g., an increase in the conduction angle).

In some embodiments, the conduction angle of the electric motor 140 may be varied to increase the conduction angle. Generally, a conduction angle applied to a BLDC motor (e.g., the electric motor 140) is set to a default value (e.g., approximately 105°, approximately 120°, between 90° and 120°, etc.). However, in order to increase speed, such as via field weakening, the conduction angle for a given phase may be increased up to a maximum value, such as 180°.

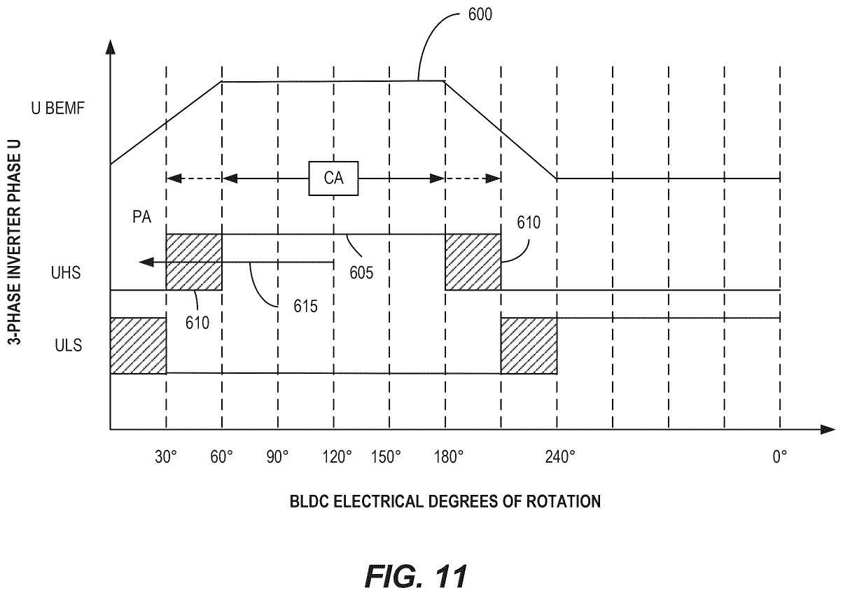

FIG. 11 shows an example of commutation applied to a BLDC motor such as the electric motor 140. A back emf (“BEMF”) 600 is generated during operation of the electric motor 140 and generally tracks with the conduction angle 605. As shown in FIG. 6, the conduction angle 605 may generally be 120° and may be applied to either a high side switch (such as high side FETs) or low side switches (such as low side FETs) as described above, in order to drive the electric motor 140. As further shown in FIG. 11, in order to increase speed, the conduction angle 605 may be increased via field weakening (as shown by optional conduction regions 610) from 120° to a maximum value, such as 180°. Further, the conduction angle 605 may be shifted to occur earlier in the conduction cycle (i.e., phase advance), as shown by phase advance line 615. In some embodiments, the controller 200 may use a single or combination of field weakening methodologies of this disclosure to control the electric motor 140.

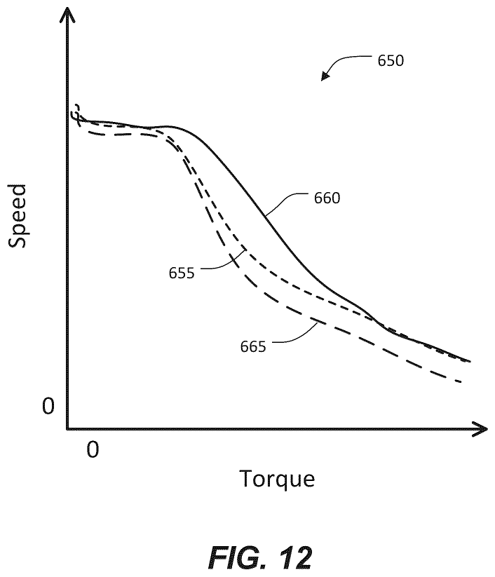

FIG. 12 is a graph 650 illustrating a relationship between torque of the electric motor 140 and speed, i.e., revolutions per minute (“RPM”) of the motor 140 for both a high-capacity battery pack (e.g., the battery pack 800 described herein) and a low-capacity battery pack (i.e., the battery pack 700 described herein. Specifically, the graph 650 illustrates an increase in torque of the motor 140 as the speed of the electric motor 140 generally decreases. Line 655 shows the relationship between torque and speed during a normal operation of the circular saw 100 with the high-capacity battery pack when no field weakening techniques are implemented. Line 660 shows the relationship between torque and speed during operation with the high-capacity battery pack while implementing the current-based field weakening techniques described herein where, e.g., the conduction angle is increased (or maximized) and the current is limited. Line 660 may represent a maximum power field weakening technique. As shown in FIG. 12, the power output of the motor 140, which may be considered as the product of speed and torque, is generally increased for line 660 as compared to the traditional operation without field weakening represented by line 655. The increase in maximum power of the motor 140 is achieved by the field weakening technique at the expense of decreased efficiency and faster exhaustion of battery pack throughput. Line 665 shows the relationship between torque and speed during a normal operation of the circular saw 100 with the low-capacity battery pack when no field weakening techniques are implemented. Due to the lower capacity of the low-capacity battery pack, the controller 200 may not implement a maximum power field weakening technique in order to preserve battery capacity and extend runtime.

Additional or alternative techniques for controlling field weakening in a power tool can also be implemented. For example, field weakening can be controlled based upon a characteristic of a battery pack, such as impedance or nominal capacity. Such field weakening control techniques for electric motors in power tools are described in greater detail in, for example, International Patent Application Publication No. WO2023/137412, published Jul. 20, 2023 and entitled “POWER TOOL CONTROLLING FIELD WEAKENING,” the entire content of which is hereby incorporated by reference.

In other examples, instead of the current-based field weakening control described herein, the controller 200 can instead execute a position-based field weakening control scheme based on the inputs of the Hall Effect sensors 220 (FIG. 9). In these examples, the controller 200 directly monitors a position of the rotor assembly 160 and, based on the rotor position, executes the position-based field weakening control scheme by operating the switching bridge 210 to vary or increase the conduction angle.

FIG. 13 illustrates the rechargeable battery pack 700 according to some embodiments. The rechargeable battery pack 700 includes a housing 705 and a device interface portion 710 for connecting the rechargeable battery pack 700 to a device (e.g., a power tool, the circular saw 100, etc.). The rechargeable battery pack 700 includes a plurality of battery cells 715 within the housing 705.

FIG. 14 illustrates a group 720 of the battery cells 715 that include, for example, 6 individual battery cells 715. The battery cells 715 can be located within the housing 705 of the rechargeable battery pack 700. In some embodiments, the rechargeable battery pack 700 includes more or fewer than 3 battery cells within the housing 705. In the illustrated embodiment, the battery pack 700 is a “3S” or “3S1P” battery pack having 3 cells 715 electrically connected in series. The battery pack 700 can have a nominal voltage rating of approximately 12 Volts (V) and a nominal capacity rating of 2.5 ampere-hours (Ah). In some examples, the nominal voltage rating of approximately 12 V can include nominal voltage ratings of 12 V plus or minus 25%. The battery pack 700 may be considered a low capacity battery pack for purposes of this disclosure.

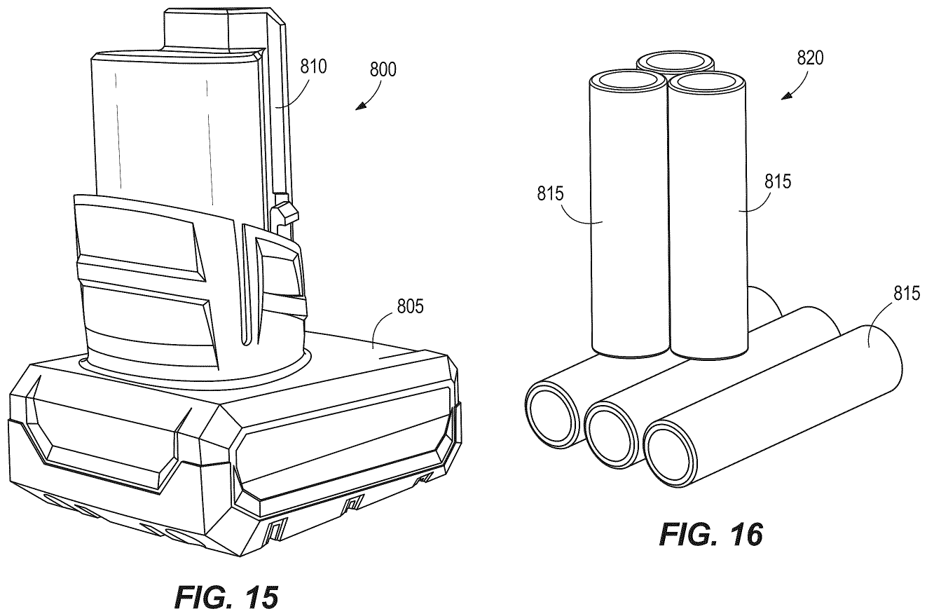

FIG. 15 illustrates the battery pack 800 according to some embodiments. The battery pack 800 includes a housing 805 and a device interface portion 810 for connecting the rechargeable battery pack 800 to a device (e.g., a power tool, the circular saw 100, etc.). The rechargeable battery pack 800 includes a plurality of battery cells 815 within the housing 805.

FIG. 16 illustrates a group 820 of the battery cells 815 that include, for example, 6 individual battery cells 815. The battery cells 815 can be located within the housing 805 of the rechargeable battery pack 800. In some embodiments, the rechargeable battery pack 800 includes more or fewer than 6 battery cells within the housing 805. In the illustrated embodiment, the battery pack 800 is a “3S2P” battery pack having 2 groups of the cells 815 electrically connected in parallel with 3 of the cells 815 electrically connected in series within each group. The battery pack 800 can have a nominal voltage rating of 12 Volts (V) and a nominal capacity rating of 5 ampere-hours (Ah). In some examples, the nominal voltage rating of approximately 12 V can include nominal voltage ratings of 12 V plus or minus 25%. The battery pack 800 may be considered a high capacity battery pack for purposes of this disclosure.

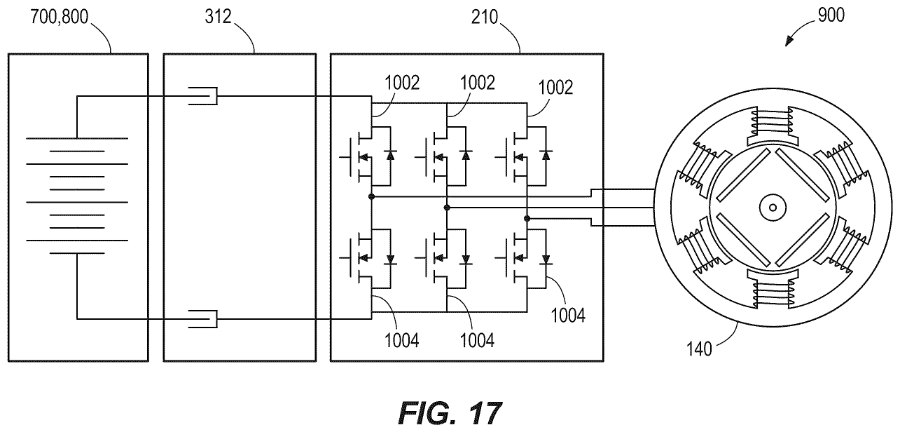

FIG. 17 illustrates a circuit diagram 900 of the switching bridge 210. The switching bridge 210 includes a number of high side power switching elements 1002 (high side FETs 1002) and a number of low side power switching elements 1004 (low side FETs 1004). The controller 200 provides the control signals to control the high side FETs 1002 and the low side FETs 1004 to drive the electric motor 140 based on the motor feedback information and user controls, as described above. The circuit diagram 900 further illustrates the battery pack (e.g., such as the battery packs 700, 800) electrically coupled to the battery receptacle 152, which is electrically connected to the switching bridge 210.

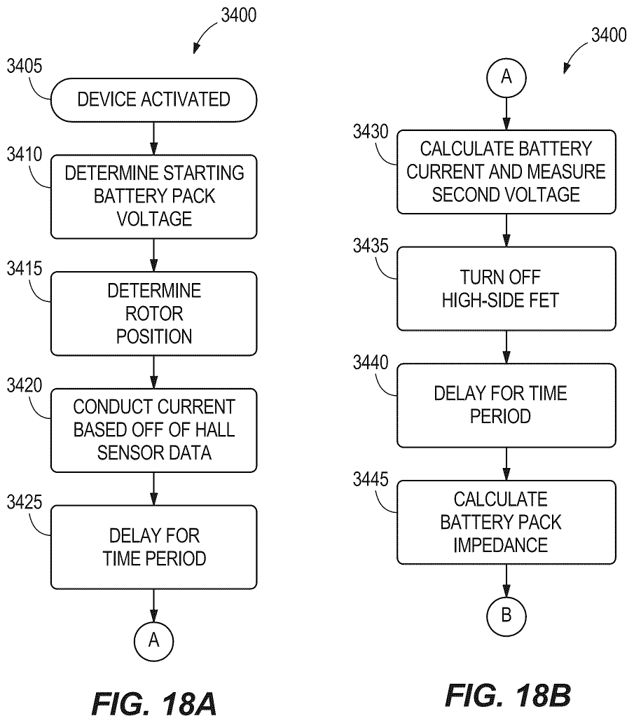

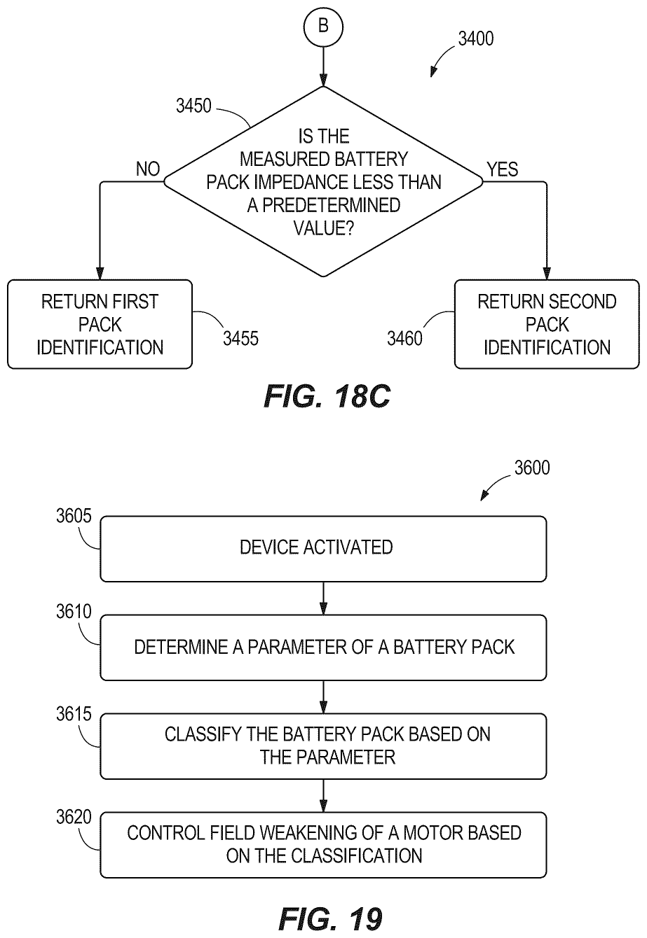

FIGS. 18A-18C illustrate a method 3400 executed by the controller 200 to determine an impedance of the battery pack (e.g., such as the battery packs 700, 800) that is coupled to the battery receptacle 152. The circular saw 100 is activated (STEP 3405) to initialize the method 3400 by the controller 200. The controller 200 receives or measures the battery pack voltage from the battery pack, and the controller 200 determines or calculates a starting battery pack voltage V start (STEP 3410). The controller 200 then receives one or more signals from one or more sensors (e.g., hall effect sensors 220) related to a rotational position of the rotor assembly 160. Data corresponding to the one or more signals are stored within the memory 260 for determining rotor position (STEP 3415). Using the data received from the hall effect sensors 220, the controller 200 initiates power to one or more high side FETs 1002 and one or more low side FETs 1004, which consequently conducts current through the motor 140 (STEP 3420). A delay is then instituted to allow for a flow of current through the system (STEP 3425). The delay allows for the current to rise to a level that can be reliably read with sufficient resolution. FIG. 18B illustrates a continuation of the method 3400 executed by the controller 200. After implementing a delay at STEP 3425, the controller 200 samples a current sense input to an analog-to-digital converter (“ADC”) and receives or measures a second voltage (e.g., sampling a voltage sense input to an ADC). In some embodiments, multiple samples are taken within a measurement. The controller 200 uses the sampled current sense input to then calculate a current of the rechargeable battery pack, I bat, and a second voltage measurement V end (STEP 3430). The controller 200 then turns off the low side FETs 1004 to allow the high side FETs 1002 to freewheel current (STEP 3435). Another delay is used to allow the high side power switches 1002 to freewheel current for an amount of time (STEP 3440).

Using the starting battery voltage from STEP 3410, the second battery voltage from STEP 3430, and the calculated current of the rechargeable battery pack 12 from STEP 3430, the controller 200 is configured to determine the impedance of the rechargeable battery pack (STEP 3445). The impedance of the rechargeable battery pack 12 can be calculated by the controller 200 using, for example, equation (10).

Z_{pack}=Vₛₜₐᵣₜ−V_{end}/I_{bat} EQN. (1)

Although EQN. (1) provides one example of how battery pack impedance can be determined, other techniques for determining battery pack impedance can also be used.

In another embodiment of estimating impedance of the battery pack, the rate of voltage drop and rate of current increase can be used in relation of the inductance of the system. The voltage drop is measured at least twice, and assumes a fixed inductance. In another embodiment of estimating impedance of the battery pack, the measurement of current alone may also be used to estimate general impedance of the battery pack. In another embodiment of estimating impedance of the battery pack, the integration of measured current over time may be used to find an estimation of the impedance of the battery pack. Similarly, the integration of voltage over time may be used to find an estimation of the impedance of the battery pack. Similarly, the derivative of the rising current and/or the derivative of the falling voltage may also be used to find an estimation of the impedance of the battery pack.

In another embodiment of estimating impedance of the battery pack, during an inrush current technique, voltage and current samples are measured to perform a slope calculation to find impedance. The slope calculation can feed into another algorithm (e.g., a neutral net, filter functions, etc.) to derive multiple aspects of the impedance (e.g., resistance, capacitance, inductive loading, etc.). Additionally, the inrush technique could be used with multiple inrush spikes and the results can be combined for a more precise output.

FIG. 18C is a continuation of method 3400. At STEP 3450, the controller 200 determines whether the measured battery pack impedance Z_{pack} is less than a predetermined value. If, at STEP 3450, the calculated impedance is greater than or equal to a certain predetermined value (e.g., a value of 50 to 80 milli-Ohms), the controller 200 is configured to determine that the rechargeable battery pack is a first type of battery pack (STEP 3455). The first type of battery pack can correspond to the battery pack 800, i.e., a high capacity battery pack. If, at STEP 3450, the calculated impedance is less than the certain predetermined value, the controller 200 is configured to determine that the rechargeable battery pack is a second type of battery pack (STEP 3460). The second type of battery pack can correspond to the battery pack 700, i.e., a low capacity battery pack. In some embodiments, multiple impedance thresholds are included for determining the type of battery pack. In some embodiments, the impedance is a continuous parameter that is used to identify the type of battery pack (e.g., using a lookup table). In another embodiment, the voltage and/or current of the system may be measured by the battery pack. In other embodiments, the voltage and/or current measurements may be communicated to the tool (e.g., via digital or analog interface). In other embodiments, the battery pack may self-calculate its own impedance. The battery pack may communicate the self-calculated impedance of the battery pack to the power tool. In another embodiment, the power tool may calculate the impedance of the battery pack, then communicate the result of the calculation to the battery pack.

FIG. 19 illustrates a method 3600 executed by the controller 200 of the circular saw 100. The circular saw 100 is powered on (STEP 3605) to initialize the method 3600 by the controller 200. For example, circular saw 100 may be activated by detecting activation of the trigger 148, which causes the attached battery pack to deliver power to the circular saw 100. The controller 200 then determines a parameter of the rechargeable battery pack (e.g., using one of the methods described above) (STEP 3610). A parameter of the rechargeable battery pack may include, for example, a battery pack impedance, battery pack capacity (e.g., ampere-hour capacity), battery pack state-of-charge (SOC), battery pack identifier, or the like. For example, the controller 200 can determine an impedance of the rechargeable battery pack or a type of the rechargeable battery pack according to the method 3400 described herein. The controller 200 then assigns a classification to the rechargeable battery pack based on the parameter determined in STEP 3610 (STEP 3615). A classification of the rechargeable battery pack may be, for example, a high-capacity battery classification or a low-capacity battery classification. In some embodiments, the controller 200 assigns a battery pack a high-capacity battery classification when the capacity of the battery pack exceeds, e.g, a 3 ampere-hour threshold. Thus, the controller 200 would determine that the battery pack 800 is a high-capacity battery pack according to the method 3600. In other embodiments, the controller 200 assigns a battery pack a low-capacity battery classification when the capacity of the battery pack is less than or equal to a 3 ampere-hour threshold. Thus, the controller 200 would determine that the battery pack 700 is a low-capacity battery pack according to the method 3600. In various embodiments, a classification is related to a determined parameter of the rechargeable battery.

The controller 200 then controls field weakening of the electric motor 140 of the circular saw 100 (e.g., using one of the methods described above) based on the classification of the rechargeable battery pack (STEP 3620). For example, controlling field weakening of the electric motor 140 includes enabling, disabling, dynamically modifying, or setting a fixed amount of field weakening applied to the electric motor 140. In one instance, if the controller 200 determines that the rechargeable battery pack is assigned a high-capacity classification (e.g., the battery pack 800), then the controller 200 enables field weakening of the motor 140. For example, the controller 200 can implement the maximum power field weakening technique described herein with respect to FIG. 12 to achieve greater maximum power output of the motor 140 because the decreased efficiency may be acceptable with the high-capacity battery pack. In another instance, if the controller 200 determines that the rechargeable battery pack is assigned a low-capacity classification, then the controller 200 disables field weakening of the motor 140. In yet another instance, if the controller 200 determines that the rechargeable battery pack is assigned a low-capacity classification, field weakening may still be implemented, but the controller 200 can enable a reduced intensity of the field weakening of the motor 140.

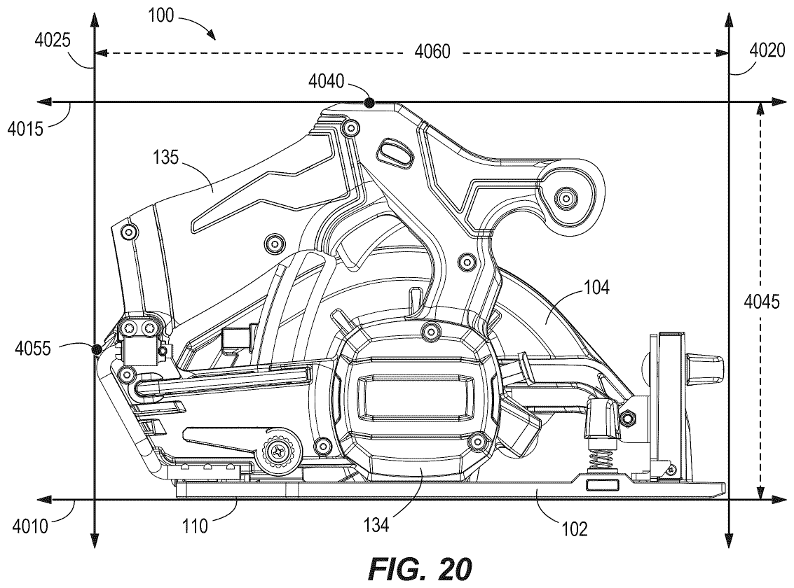

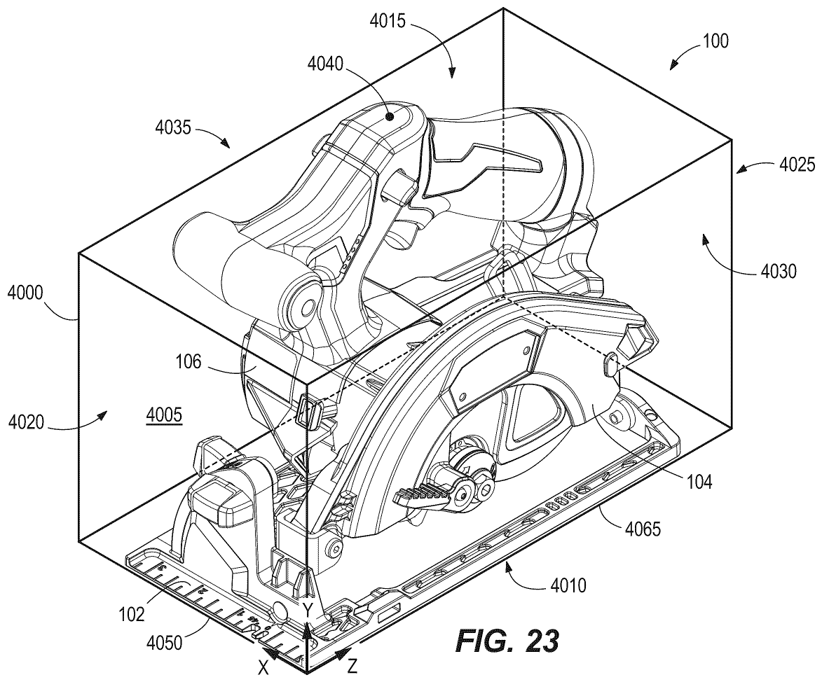

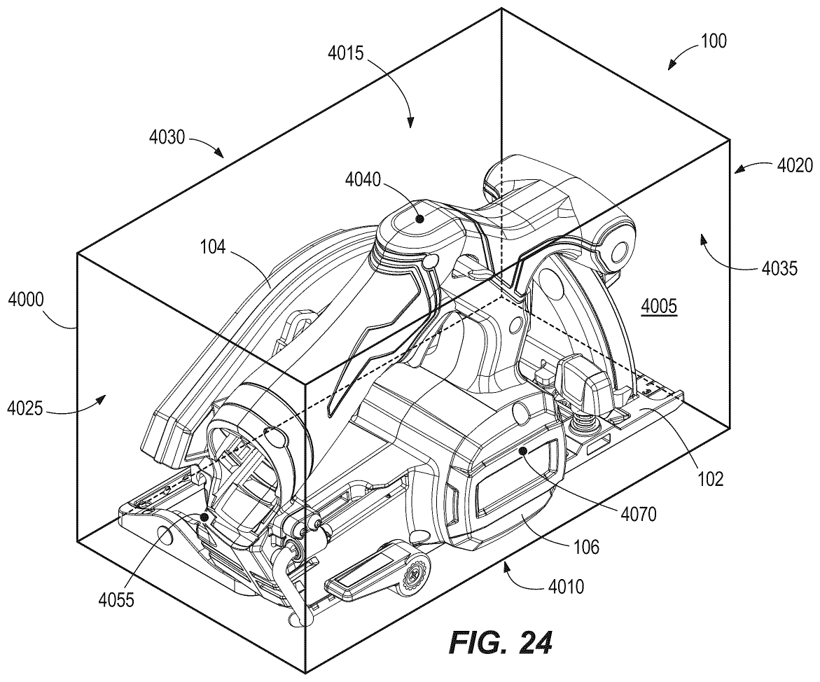

With reference to FIGS. 20-24, the circular saw 100 has a relatively compact arrangement, or a small “form factor,” as compared to most traditional circular saws which are configured to operate with the saw blade 108 having a diameter of approximately 5⅜ inches. In other words, as compared to such similar traditional circular saws, the circular saw 100 occupies a relatively small three-dimensional space. For example, FIGS. 20-24 show the circular saw 100 arranged with the battery pack removed and with the lower blade guard 116 moved to a fully retracted position where it resides above the workpiece contact surface 110. In this configuration, the circular saw 100 may reside entirely within a three-dimensional space bounded by a rectangular parallelogram 4000 illustrated in FIGS. 23 and 24.

In the illustrated embodiment, the rectangular parallelogram 4000 has a volume 4005 of approximately 424 cubic inches (in³). In some embodiments, the volume 4005 of the rectangular parallelogram 4000 can be less than or equal to 550 in³ to maintain a compact arrangement. In other embodiments, to maintain the compact arrangement, the volume 4005 of the rectangular parallelogram 4000 can be less than or equal to 500 in³, or less than or equal to 475 in³, or less than or equal to 450 in³, or less than or equal to 425 in³, or less than or equal to 424 in³. In further embodiments, to maintain the compact arrangement, the volume 4005 of the rectangular parallelogram 4000 can be less than or equal to 550 in³ and greater than or equal to 300 in³. In other embodiments, the volume 4005 can be less than or equal to 500 in³ and greater than or equal to 350 in³. In further embodiments, the volume 4005 can be less than or equal to 450 in³ and greater than or equal to 400 in³.

As shown in FIGS. 20-24, the rectangular parallelogram 4000 is bounded by six planes arranged in parallel pairs. The six planes include a first XZ plane 4010, a second XZ plane 4015, a first XY plane 4020, a second XY plane 4025, a first YZ plane 4030, and a second YZ plane 4035.

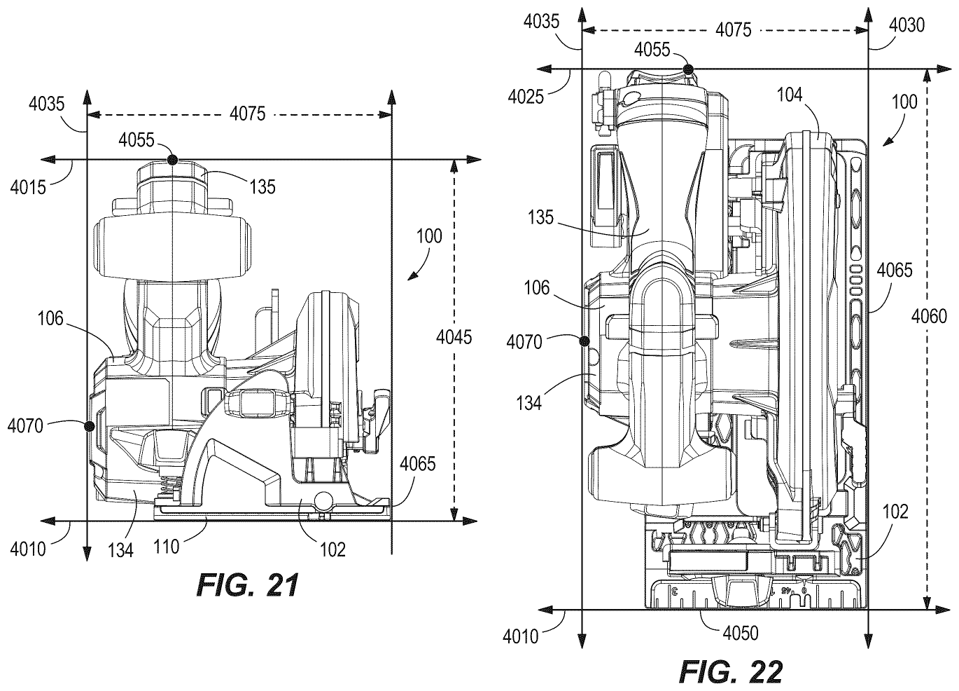

As shown in FIGS. 20 and 21, the first XZ plane 4010 is defined by the workpiece contact surface 110 of the shoe 102. The second XZ plane 4015 extends parallel to the first XZ plane 4010 and tangent to a first apex point 4040 of the circular saw 100 that is defined on the handle portion 135. The first apex point 4040 is a point located on a surface of the circular saw 100 that is furthest from the first XZ plane 4010 along a direction normal to the first XZ plane 4010. Although the first apex point 4040 is defined by the housing assembly 106 in the illustrated embodiment, in other embodiments the first apex point 4040 may be defined by another feature of the circular saw 100 (e.g., the guard assembly, etc.). A first dimension of the circular saw 100, or a height 4045, is measured between the first XZ plane 4010 and the second XZ plane 4015 and normal thereto. In the illustrated embodiment, the height 4045 is 6.8125 inches (in).

As shown in FIGS. 20 and 22, the first XY plane 4020 extends tangent to a forwardmost edge 4050 of the shoe 102 in a cutting direction of the circular saw 100. The first XY plane 4020 is also perpendicular to the first XZ plane 4010. The second XY plane 4025 extends parallel to the first XY plane 4020 and tangent to a second apex point 4055 of the circular saw 100 that is defined on the housing assembly 106 at or near the battery receptacle 152. The second apex point 4055 is a point located on a surface of the circular saw 100 that is furthest from the first XY plane 4020 along a direction normal to the first XY plane 4020. Although the second apex point 4055 is defined by the housing assembly 106 in the illustrated embodiment, in other embodiments the second apex point 4055 may be defined by another feature of the circular saw 100 (e.g., the guard assembly, the shoe, etc.). A second dimension of the circular saw 100, or a length 4060, is measured between the first XY plane 4020 and the second XY plane 4025 and normal thereto. In the illustrated embodiment, the length 4060 is 10.8125 inches (in).

As shown in FIGS. 21 and 22, the first YZ plane 4030 extends tangent to a side edge 4065 of the shoe 102. The side edge 4065 extends generally parallel to a longitudinal axis of the shoe 102, adjacent the blade guard assembly 104, and distant from the housing assembly 106. The first YZ plane 4030 is also perpendicular to the first XZ plane 4010 and to the first XY plane 4020. The second YZ plane 4035 extends parallel to the first YZ plane 4030 and tangent to a third apex point 4070 of the circular saw 100 that is defined on the housing assembly 106 at or near the motor housing portion 134. The third apex point 4070 is a point located on a surface of the circular saw 100 that is furthest from the first YZ plane 4030 along a direction normal to the first YZ plane 4030. Although the third apex point 4070 is defined by the housing assembly 106 in the illustrated embodiment, in other embodiments the third apex point 4070 may be defined by another feature of the circular saw 100 (e.g., the guard assembly, the shoe, etc.). A third dimension of the circular saw 100, or a width 4075, is measured between the first YZ plane 4030 and the second YZ plane 4035 and normal thereto. In the illustrated embodiment, the width 4075 is 5.75 inches (in). In some embodiments, the width 4075 is less than or equal to 6.00 in.

As discussed herein, the circular saw 100 is configured to operate with the controller 200 implementing the field weakening control techniques to adjust the speed, torque, and/or power output by the electric motor 140. As such, the electric motor 140 is capable of outputting a peak power P of approximately 505 Watts under the maximum power field weakening technique (described herein with respect to FIG. 12) implemented by the controller 200 to maximize the power output of the motor (e.g., by increasing the conduction angle and/or adjusting the current as described herein). In some embodiments, the peak power P is greater than or equal to 500 Watts. The peak power P of 505 Watts may be achieved with the battery pack 800, i.e., a high capacity battery pack. However, the peak power P may be lower when the circular saw 100 is operated with the battery pack 700, i.e., a low capacity battery pack, because the controller 200 may not implement the maximum power field weakening technique when the low capacity battery pack is being utilized, in order to conserve power throughput and increase tool runtime. Whether a high capacity battery pack or a low capacity battery pack is connected to the circular saw 100 may be determined by the controller 200 according to the method 3600 described herein, or according to other methods.

In other examples, the circular saw 100 may be operated with an improved high capacity battery pack (not shown) having improved characteristics compared to the battery pack 800 described herein. For example, the improved high capacity battery pack may have the same capacity as the battery pack 800 (e.g., 5 Ah), but may have a greater peak power delivery than the battery pack 800. In other examples, both the capacity and the peak power delivery of the improved high capacity battery pack may be greater than those of the battery pack 800. When operated with the improved high capacity battery pack, the circular saw 100 is configured to operate with the controller 200 implementing the field weakening control techniques to adjust the speed, torque, and/or power output by the electric motor 140. As such, with the improved high capacity battery pack, the electric motor 140 is capable of outputting a peak power P of approximately 563 Watts under the maximum power field weakening technique (described herein with respect to FIG. 12) implemented by the controller 200 to maximize the power output of the motor (e.g., by increasing the conduction angle and/or adjusting the current as described herein). In some embodiments, the peak power P is greater than or equal to 550 Watts.

As discussed herein, in the configuration of the circular saw 100 shown in FIGS. 20-24, i.e., with the battery pack removed and the saw blade 108 removed, the circular saw 100 may reside entirely within the three-dimensional space bounded by a rectangular parallelogram 4000 illustrated in FIGS. 23 and 24. The circular saw 100 may have a ratio of the peak power P to the volume 4005 (i.e., a power-volume ratio PV). In the illustrated embodiment, when operating with a high capacity battery pack such as the battery pack 800 described herein, the power-volume ratio PV is approximately 1.19 Watts/in.³. In another example, when operating with the improved high capacity battery pack described herein, the power-volume ratio PV is approximately 1.33 Watts/in.³. In other embodiments, the power-volume ratio PV may be greater than or equal to 1.19 Watts/in.³. In further embodiments, the power-volume ratio PV may be greater than or equal to 1.00 Watts/in.³ and less than or equal to 2.00 Watts/in.³. In other embodiments, the power-volume ratio PV may be greater than or equal to 1.10 Watts/in.³ and less than or equal to 1.19 Watts/in.³. In some embodiments, the power-volume ratio PV may be greater than or equal to 1.00 Watts/in.³ and less than or equal to 1.50 Watts/in.³. In some embodiments, the power-volume ratio PV may be greater than or equal to 1.10 Watts/in.³ and less than or equal to 1.40 Watts/in.³. Due to the compact arrangement of the circular saw 100 and the relatively high peak power P achieved due, in part, to the field weakening techniques described herein, the circular saw 100 has a higher power-volume ratio PV than traditional circular saws operable with the saw blade 108.

In the configuration of the circular saw 100 shown in FIGS. 20-24, i.e., with the battery pack removed and the saw blade 108 removed, the circular saw 100 has a weight W of approximately 4.47 pounds (lbs.). In some embodiments, the weight W is less than or equal to 4.50 lbs. The circular saw 100 may have a ratio of the peak power P to the weight W (i.e., a power-weight ratio PW). In the illustrated embodiment, when operating with a high capacity battery pack such as the battery pack 800 described herein, the power-weight ratio PW is approximately 113 Watts/lb. In another example, when operating with the improved high capacity battery pack described herein, the power-weight ratio PW is approximately 126 Watts/lb. In other embodiments, the power-weight ratio PW may be greater than or equal to 113 Watts/lb. In further embodiments, the power-weight ratio PW may be greater than or equal to 105 Watts/lb. and less than or equal to 150 Watts/lb. In other embodiments, the power-weight ratio PW may be greater than or equal to 110 Watts/lb. and less than or equal to 113 Watts/lb. Due to the compact arrangement of the circular saw 100 and the relatively high peak power P achieved due, in part, to the field weakening techniques described herein, the circular saw 100 has a higher power-weight ratio PW than traditional circular saws operable with the saw blade 108.

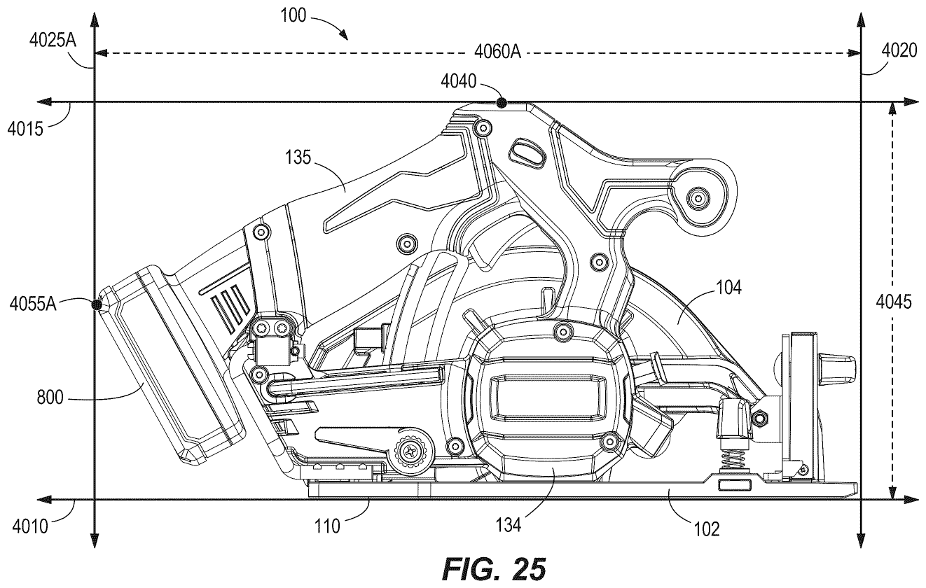

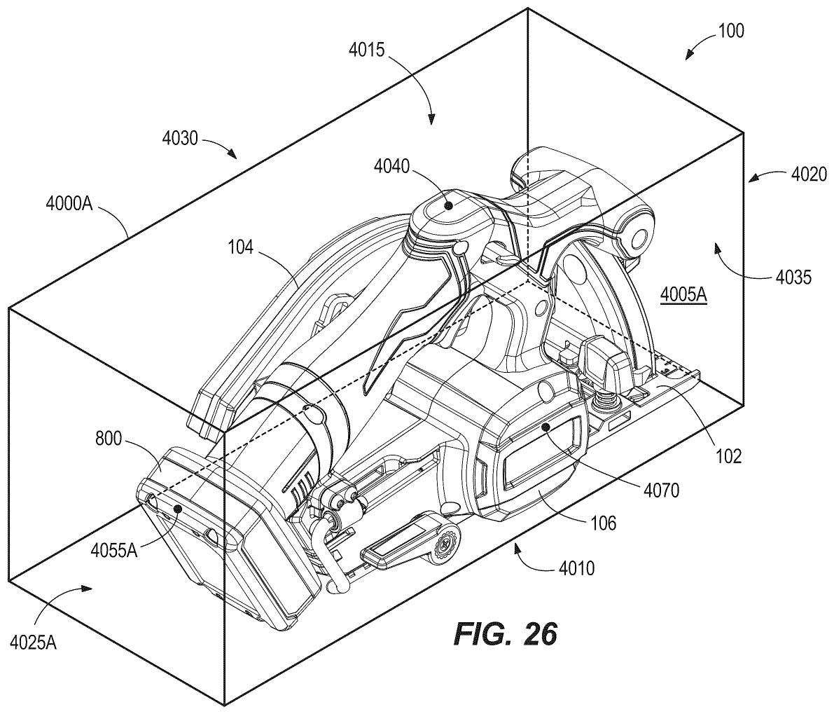

FIGS. 25 and 26 illustrate the circular saw 100 arranged with the battery pack 800 connected thereto and with the lower blade guard 116 moved to a fully retracted position where it resides above the workpiece contact surface 110. In this configuration, the circular saw 100 may reside entirely within a three-dimensional space bounded by a rectangular parallelogram 4000A illustrated in FIG. 26. The rectangular parallelogram 4000A is substantially similar to the rectangular parallelogram 4000 described herein with respect to FIGS. 20-24 and like features are assigned like reference numbers. The rectangular parallelogram 4000A differs from the rectangular parallelogram 4000 because the second XY plane 4025A is defined by a second apex point 4055A located on the battery pack 800 rather than the housing assembly 106. As such, the length 4060A of the circular saw 100 in this configuration is different, i.e., longer, than the length 4060 heretofore described. Specifically, the length 4060A is 12.3125 inches (in) in the illustrated embodiment.

In the configuration illustrated in FIGS. 25 and 26, the rectangular parallelogram 4000A has a volume 4005A of approximately 482 cubic inches (in³). In some embodiments, the volume 4005A of the rectangular parallelogram 4000A can be less than or equal to 550 in³ to maintain a compact arrangement. In other embodiments, to maintain the compact arrangement, the volume 4005A of the rectangular parallelogram 4000A can be less than or equal to 500 in³, or less than or equal to 490 in³, or less than or equal to 485 in³, or less than or equal to 482 in³. In further embodiments, to maintain the compact arrangement, the volume 4005A of the rectangular parallelogram 4000A can be less than or equal to 550 in³ and greater than or equal to 300 in³. In other embodiments, the volume 4005A can be less than or equal to 500 in³ and greater than or equal to 350 in³. In further embodiments, the volume 4005A can be less than or equal to 490 in³ and greater than or equal to 460 in³.

In the configuration of the circular saw 100 shown in FIGS. 25-26, i.e., with the battery pack 800 connected thereto and the saw blade 108 removed, the circular saw 100 may reside entirely within the three-dimensional space bounded by the rectangular parallelogram 4000A illustrated in FIG. 26. The circular saw 100 in this configuration may have a ratio of the peak power P to the volume 4005A (i.e., a power-volume ratio PV 2). In the illustrated embodiment, the power-volume ratio PV 2 is approximately 1.05 Watts/in.³. In other embodiments, the power-volume ratio PV 2 may be greater than or equal to 1.05 Watts/in.³. In further embodiments, the power-volume ratio PV 2 may be greater than or equal to 0.90 Watts/in.³ and less than or equal to 2.00 Watts/in.³. In other embodiments, the power-volume ratio PV 2 may be greater than or equal to 0.90 Watts/in.³ and less than or equal to 1.50 Watts/in.³. In other embodiments, the power-volume ratio PV 2 may be greater than or equal to 1.00 Watts/in.³ and less than or equal to 1.05 Watts/in.³. Due to the compact arrangement of the circular saw 100 and the relatively high peak power P achieved due, in part, to the field weakening techniques described herein, the circular saw 100 has a higher power-volume ratio PV than traditional circular saws operable with the saw blade 108.

Table 1 below compares the characteristics of the circular saw 100 described herein to three conventional prior art circular saws which are also configured to operate a 5⅜ inch diameter saw blade. The characteristics of the circular saw 100 listed in Table 1 include the operating voltage, the weight W, the height 4045, the length 4060, the width 4075, the peak power P, the volume 4005, the power-volume ratio PV, and the power-weight ratio PW.

TABLE 1

| | Circular | | | | |
|---|---|---|---|---|---|
| | Saw | Circular | | | |
| | 100 With | Saw | | | |
| | Improved | 100 With | | | |
| | High | High | | | |
| | Capacity | Capacity | Prior | Prior | Prior |
| | Battery | Battery | Art | Art | Art |
| | Pack | Pack | Saw 1 | Saw 2 | Saw 3 |
| Voltage (V) | 12 | 12 | 12 | 12 | 12 |
| Bare Weight (lbs) | 4.47 | 4.47 | 4.59 | 4.78 | 5.35 |
| Length (in) | 10.8125 | 10.8125 | 11.35 | 10.79 | 12.2 |
| Length w/Bat | 12.3125 | 12.3125 | 13.5 | 12.625 | 14.51 |
| (in) | | | | | |
| Width (in) | 5.75 | 5.75 | 6.1 | 6.46 | 6.97 |
| Height (in) | 6.8125 | 6.8125 | 6.87 | 7.73 | 6.375 |
| Peak Power (W) | 563 | 505 | 459 | 490 | 340 |
| Volume (in\hat{ }3) | 424 | 424 | 476 | 539 | 542 |
| Watt/in\hat{ }3 | 1.33 | 1.19 | 0.97 | 0.91 | 0.63 |
| Watt/lb | 126 | 113 | 100 | 103 | 64 |

Various features of the invention are set forth in the following claims.

What is claimed is:

1. A circular saw configured to operate a saw blade having a diameter of 5⅜ inches, the circular saw comprising:
a shoe defining a slot and a workpiece contact surface;
a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface;
a housing assembly coupled to the blade guard assembly;
an output shaft;
a blade clamp coupled to output shaft, the blade clamp configured to hold the saw blade;
a brushless direct current (DC) motor positioned within the housing assembly and operable to rotate the output shaft;
an electronic controller configured to:
set a conduction angle of the brushless DC motor,
supply a pulse-width modulated (“PWM”) signal having a duty cycle to the brushless DC motor to control a current of the brushless DC motor, and
perform a field weakening operation to modify the conduction angle of the brushless DC motor;
wherein the circular saw is configured to operate with a battery pack having a nominal voltage rating of approximately 12 Volts;
wherein in response to the lower blade guard residing in the retracted position, the circular saw fits entirely within a volume bounded by a rectangular prism;
wherein the brushless DC motor is configured to produce a peak power; and
wherein a power-volume ratio of the peak power to the volume is greater than or equal to 1.00 Watts/in.³ and less than or equal to 2.00 Watts/in.³.

2. The circular saw of claim 1, wherein the rectangular prism is defined by:
a first XZ plane that is defined by the workpiece contact surface;
a second XZ plane that extends parallel to the first XZ plane and tangent to a first apex point on the circular saw located furthest from the first XZ plane along a direction normal to the first XZ plane;
a first XY plane that extends perpendicular to the first XZ plane and tangent to a forwardmost edge of the shoe;
a second XY plane that extends parallel to the first XY plane and tangent to a second apex point on the circular saw located furthest from the first XY plane along a direction normal to the first XY plane;
a first YZ plane that extends perpendicular to the first XZ plane and tangent to a most sideward edge of the shoe;
a second YZ plane that extends parallel to the first YZ plane and tangent to a third apex point on the circular saw located furthest from the first YZ plane along a direction normal to the first YZ plane.

3. The circular saw of claim 2, wherein a width of the circular saw is measured perpendicularly from the first YZ plane to the second YZ plane, and wherein the width is less than or equal to 6.00 inches (in.).

4. The circular saw of claim 1, wherein:
the electronic controller is configured to determine whether a capacity of the battery pack exceeds a threshold capacity; and
when the capacity of the battery pack exceeds the threshold capacity, the electronic controller performs the field weakening operation; and
when the capacity of the battery pack does not exceed the threshold capacity, the electronic controller does not perform the field weakening operation.

5. The circular saw of claim 4, wherein the threshold capacity is 3 ampere-hours.

6. The circular saw of claim 1, wherein the electronic controller is configured to advance the conduction angle for a phase of the brushless DC motor up to a maximum conduction angle of 180°.

7. The circular saw of claim 1, wherein the volume is less than or equal to 450 cubic inches (in³).

8. The circular saw of claim 7, wherein the peak power is greater than or equal to 500 Watts.

9. The circular saw of claim 1, wherein the circular saw defines a weight that is less than or equal to 4.50 pounds (lbs.).

10. The circular saw of claim 1, wherein the power-volume ratio of the peak power to the volume is greater than or equal to 1.10 Watts/in.³ and less than or equal to 1.40 Watts/in.³.

11. A circular saw configured to operate a saw blade having a diameter of 5⅜ inches, the circular saw comprising:
a shoe defining a slot and a workpiece contact surface;
a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface;
a housing assembly coupled to the blade guard assembly;
an output shaft;
a blade clamp coupled to output shaft, the blade clamp configured to hold the saw blade;
a brushless direct current (DC) motor positioned within the housing assembly and operable to rotate the output shaft;
an electronic controller configured to:
set a conduction angle of the brushless DC motor,
supply a pulse-width modulated (“PWM”) signal having a duty cycle to the brushless DC motor to control a current of the brushless DC motor, and
perform a field weakening operation to modify the conduction angle of the brushless DC motor;
wherein the circular saw is configured to operate with a battery pack having a nominal voltage rating of approximately 12 Volts;
wherein the circular saw defines a weight;
wherein the brushless DC motor is configured to produce a peak power; and
wherein a power-weight ratio of the peak power to the weight is greater than or equal to 105 Watts/lb. and less than or equal to 150 Watts/lb.

12. The circular saw of claim 11, wherein:
in response to the lower blade guard residing in the retracted position, the circular saw fits entirely within a volume bounded by a rectangular prism; and
wherein a power-volume ratio of the peak power to the volume is greater than or equal to 1.00 Watts/in.³ and less than or equal to 2.00 Watts/in.³.

13. The circular saw of claim 12, wherein the rectangular prism is defined by:
a first XZ plane that is defined by the workpiece contact surface;
a second XZ plane that extends parallel to the first XZ plane and tangent to a first apex point on the circular saw located furthest from the first XZ plane along a direction normal to the first XZ plane;
a first XY plane that extends perpendicular to the first XZ plane and tangent to a forwardmost edge of the shoe;
a second XY plane that extends parallel to the first XY plane and tangent to a second apex point on the circular saw located furthest from the first XY plane along a direction normal to the first XY plane;
a first YZ plane that extends perpendicular to the first XZ plane and tangent to a most sideward edge of the shoe;
a second YZ plane that extends parallel to the first YZ plane and tangent to a third apex point on the circular saw located furthest from the first YZ plane along a direction normal to the first YZ plane.

14. The circular saw of claim 13, wherein a width of the circular saw is measured perpendicularly from the first YZ plane to the second YZ plane, and wherein the width is less than or equal to 6.00 inches (in.).

15. The circular saw of claim 11, wherein:
the electronic controller is configured to determine whether a capacity of the battery pack exceeds a threshold capacity; and
when the capacity of the battery pack exceeds the threshold capacity, the electronic controller performs the field weakening operation; and
when the capacity of the battery pack does not exceed the threshold capacity, the electronic controller does not perform the field weakening operation.

16. The circular saw of claim 15, wherein the threshold capacity is 3 ampere-hours.

17. The circular saw of claim 11, wherein the electronic controller is configured to advance the conduction angle for a phase of the brushless DC motor up to a maximum conduction angle of 180°.

18. A circular saw configured to operate a saw blade having a diameter of 5⅜ inches, the circular saw comprising:
a shoe defining a slot and a workpiece contact surface;
a blade guard assembly coupled to the shoe, the blade guard assembly including an upper blade guard and a lower blade guard movable between an extended position at which the lower blade guard extends through the slot and a retracted position at which the lower blade guard is positioned above the workpiece contact surface;
a housing assembly coupled to the blade guard assembly;
an output shaft;
a blade clamp coupled to output shaft, the blade clamp configured to hold the saw blade; and
a brushless direct current (DC) motor positioned within the housing assembly and operable to rotate the output shaft;
wherein the circular saw is configured to operate with a battery pack having a nominal voltage rating of approximately 12 Volts;
wherein in response to the lower blade guard residing in the retracted position, the circular saw fits entirely within a volume bounded by a rectangular prism;
wherein the brushless DC motor is configured to produce a peak power;
wherein the volume is less than or equal to 450 cubic inches (in³); and
wherein a power-volume ratio of the peak power to the volume is greater than or equal to 1.00 Watts/in.³ and less than or equal to 2.00 Watts/in.³.

19. The circular saw of claim 18, wherein the circular saw defines a weight, and wherein a power-weight ratio of the peak power to the weight is greater than or equal to 105 Watts/lb. and less than or equal to 150 Watts/lb.

20. The circular saw of claim 1, further comprising an electronic controller configured to:
set a conduction angle of the brushless DC motor,
supply a pulse-width modulated (“PWM”) signal having a duty cycle to the brushless DC motor to control a current of the brushless DC motor, and
perform a field weakening operation to modify the conduction angle of the brushless DC motor.
